(19) United States
(12) Patent Application Publication
(10) Pub. No.: US 2025/0083681 A1
(43) Pub. Date: Mar. 13, 2025

(54) COLLISION AVOIDANCE SENSITIVITY

(71) Applicant: QUALCOMM Incorporated, San Diego, CA (US)

(72) Inventors: Mohammad Hossein AKBARI AFARANI, Västra Frölunda (SE); Klas ALENLJUNG, Bohus (SE)

(21) Appl. No.: 18/466,325

(22) Filed: Sep. 13, 2023

(51) Int. Cl. B60W 50/00; G08G 1/16

(52) U.S. Cl. CPC B60W 50/0098; G08G 1/167; B60W 2520/06; B60W 2520/10; B60W 2520/105; B60W 2530/201; B60W 2552/05; B60W 2554/20; B60W 2555/80; B60W 2556/45; B60W 2710/18

(57) ABSTRACT

Techniques for improving safety margin perimeter profiles for use with Advanced Driver Assistance Systems (ADAS) functions are provided. An example method for activating an advanced driving assistance system (ADAS) function includes obtaining one or more operation parameters for a vehicle, computing an asymmetric safety margin perimeter profile around the vehicle based at least in part on the one or more operation parameters, and activating a safety function for the vehicle based at least in part on a location of an object relative to the asymmetric safety margin perimeter profile.

### BACKGROUND

The following relates generally to autonomous driving and advanced driver assistance systems (ADAS). More specifically, embodiments of the disclosure are related to reducing false alarms in collision avoidance systems.

Advanced driver assistance systems (ADAS) are systems configured to automate/adapt/enhance vehicle systems for safety and better driving. For instance, ADAS can be used to avoid collisions and accidents by alerting the driver to potential problems, or by implementing safeguards and taking over control of the vehicle. Other common features associated with ADAS include automated lighting, automated braking, global positioning system (GPS)/traffic warnings, alerts to the driver to other cars or dangers, displaying what is in blind spots, and keeping the driver in the correct lane. More complex ADAS features may include lane-following, lane departure warning, adaptive cruise control and automated lane-changes, and even autonomous driving functionality. Other features, such as autonomous emergency braking (AEB) and lane support system (LSS), may be configured to alert a driver when there is a risk of a collision with proximate objects.

### SUMMARY

An example method for activating an advanced driving assistance system (ADAS) function according to the disclosure includes obtaining one or more operation parameters for a vehicle, computing an asymmetric safety margin perimeter profile around the vehicle based at least in part on the one or more operation parameters, and activating a safety function for the vehicle based at least in part on a location of an object relative to the asymmetric safety margin perimeter profile.

An example method for computing a safety margin profile perimeter for a vehicle according to the disclosure includes obtaining location information associated with a geographic location, obtaining vehicle information associated with the vehicle operating proximate to the geographic location, and computing a safety margin perimeter profile for the vehicle based at least in part on the location information and the vehicle information.

An example apparatus according to the disclosure includes at least one memory, at least one processor communicatively coupled to the at least one memory and configured to: obtain one or more operation parameters for a vehicle, compute an asymmetric safety margin perimeter profile around the vehicle based at least in part on the one or more operation parameters, and activate a safety function for the vehicle based at least in part on a location of an object relative to the asymmetric safety margin perimeter profile.

An example apparatus according to the disclosure includes at least one memory, at least one transceiver, at least one processor communicatively coupled to the at least one memory and the at least one transceiver, and configured to: obtain location information associated with a geographic location, obtain vehicle information associated with a vehicle operating proximate to the geographic location, and compute a safety margin perimeter profile for the vehicle based at least in part on the location information and the vehicle information.

Items and/or techniques described herein may provide one or more of the following capabilities, as well as other capabilities not mentioned. An ADAS equipped vehicle may be configured with one or more collision avoidance systems such as autonomous emergency braking (AEB) and lane support system (LSS). Such ADAS functions may be activated based on a distance between the vehicle and an object. A safety margin perimeter may be established around the vehicle such that the functions are activated when an object is within, or projected to be within, the safety margin perimeter. The safety margin perimeter may be configured to improve the true positive rate for activation of a collision avoidance function, while constraining the false activation rate of the function below a threshold value. The safety margin perimeter may be asymmetric around the vehicle. The safety margin perimeter may be based on vehicle parameters and location information. Machine learning techniques may be used to determine the safety margin perimeter based on the vehicle parameters and/or the location information. Machine learning models, such as neural networks, may be provided to vehicles to enable the generation of safety margin perimeters. The machine learning models and resulting safety margin perimeters may be trained based on a combination of real-life traffic data, synthetic data, and controlled test-track scenarios. The effectiveness of ADAS functions may be improved and the risk of a collision may be reduced. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server.

FIG. 5 is a system diagram illustrating the various entities configured to utilize V2X communication links.

FIG. 6 is a block diagram of an example mobile device which is capable of computing ADAS safety margin perimeter profiles.

FIG. 7 is a diagram of an example prior art safety margin perimeter.

FIGS. 8A and 8B illustrate an example use case of an improved safety margin perimeter profile.

FIG. 9 is an example use case for location based safety margin perimeter profiles.

FIG. 10 is a diagram of example safety margin perimeter profiles.

FIG. 11 is a first example process for obtaining a safety margin perimeter profile.

FIG. 12 is a second example process for obtaining a safety margin perimeter profile.

FIG. 13 is an example machine learning (ML) based safety margin perimeter prediction module.

FIG. 14 is an example neural network for obtaining a safety margin perimeter profile.

FIG. 15 is a process flow of an example method for activating an advance driving assistance system (ADAS) function.

FIG. 16 is a process flow of an example method for computing a safety margin perimeter profile.

### DETAILED DESCRIPTION

Techniques are discussed herein for improving safety margin perimeter profiles for use with Advanced Driver Assistance Systems (ADAS) functions. V2X, including cellular V2X (C-V2X) technologies, enables radio frequency (RF) communications between vehicles and other wireless nodes, such as other vehicles, roadside units (RSUs), vulnerable road users (VRUs), and cellular networks. ADAS driving functions may include functions offering varying levels of automation based on different driving context (e.g., feet off, hands on/off, eyes on/off in highway, urban, country road, etc.). For example, the ADAS driving functions may include one or more functions as known in the art such as Autonomous Emergency Braking (AEB), Lane Support System (LSS), Keep distance (KD), Speed Keep Assist (SKA), Lane Keep Assist (LKA), Stop at stop sign (SaSS), Stop and go at traffic light (SGTL), Adapt speed and trajectory to road geometry (ASTRG), Lane Change Assist (LCA), Change lane (CL), Hands-free driving option (HFO), Give right of way (GROW), Stop and give right of way (SGROW), Emergency change lane (ECL), Keep lane (KL), and Keep speed (KS). The improved safety margin perimeter profiles described herein may be used to increase the effectiveness of some ADAS driving functions and reduce the chance of collisions with other vehicles and roadside objects.

In an example, a method used to remove false alarms in a collision avoidance system is to add a box-shaped symmetrical margin around a vehicle as a safety margin. An ADS function, such as an AEB system, may be configured to brake to avoid objects within the safety margin. A large safety margin may result in more brake interventions, while a small safety margin may result in less brake interventions but with a higher potential for more collisions.

Particular aspects of the subject matter described in the disclosure may be implemented to realize one or more of the following potential advantages. Prior box-shaped safety margins are rigid and with a symmetrical shape, which may be limited for some use cases. The improved safety margins provided herein provide nonsymmetrical non-boxy shape margins which may be modified for different vehicle operation use cases. In an example, an improved safety margin perimeter profile may be based on different input factors, such as vehicle operational parameters, and the profile parameter may be based on an output from a machine learning (ML) model. For example, a vehicle (or other network resource) may be configured with a neural network (NN) and safety margin perimeter profiles may be based on an output of the NN. The ML models may be trained based on vehicle operational parameters such as vehicle speed, acceleration, steering angle, heading angle, etc. Additional vehicle operational parameters may also be used. For example, vehicle locations may be used to train location-based safety margin perimeter profiles. In an example, due to different driving behavior in different location/countries, additional input factors may be utilized by the ML models to generate improved safety margin perimeter profiles for different locations. Network resources, such as roadside units (RSUs), may be configured to provide improved safety margin perimeter profiles and/or ML models to vehicles to enable local safety margins. For example, the features associated with the geography of a particular intersection may be input to a ML model with vehicle parameters to generate a safety margin perimeter profile to be utilized when the vehicle is proximate to, (e.g., near or within), the intersection. Other features for other locations may also be used to generate improved safety margin perimeter profiles. The improved safety margin perimeter profiles may be used to increase the effectiveness of ADAS functions and may reduce the potential for a collision. Other benefits may also be realized.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, on-board unit (OBU), etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device.” a “subscriber terminal,” a “subscriber station,” a “user terminal” or UT, a “mobile terminal,” a “mobile station,” a “mobile device,” or variations thereof. A UE disposed in a vehicle may be called an on-board unit (OBU). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (CNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (cMBB), or others) that may provide access for different types of devices. In some examples, the term “cell” may refer to a portion of a geographic coverage area (for example, a sector) over which the logical entity operates.

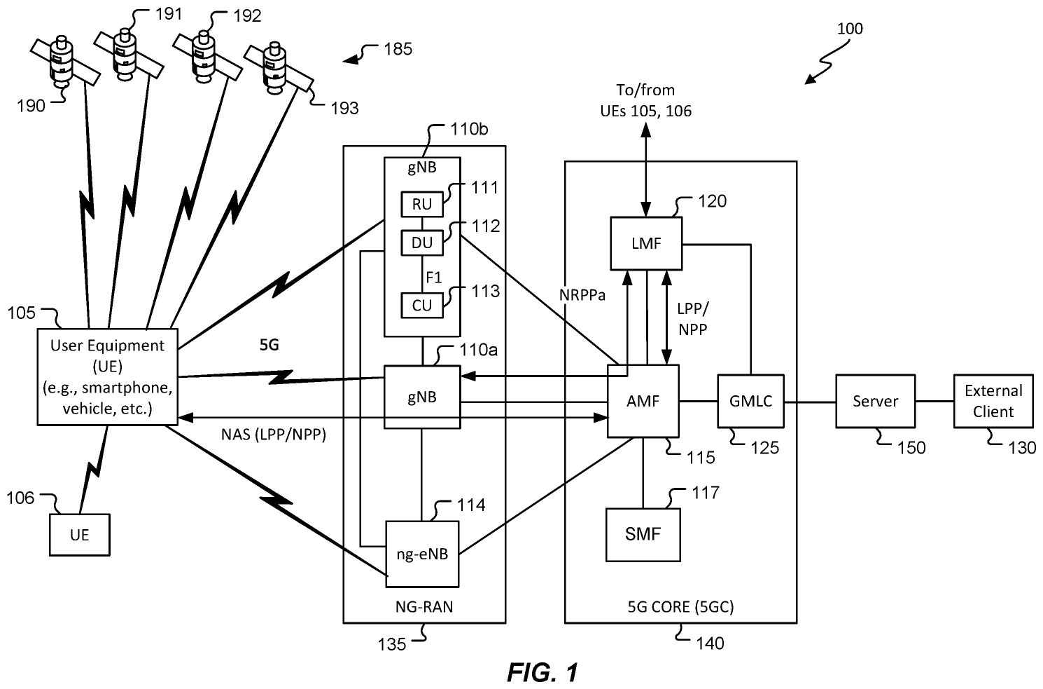

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a navigation system/OBU in a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a. 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a. 110b, and/or the ng-eNB 114. Other UEs in such a group may be outside such geographic coverage areas, or may be otherwise unable to receive transmissions from a base station. Groups of UEs communicating via D2D communications may utilize a one-to-many (1: M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1: M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a. 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a. 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may usc LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

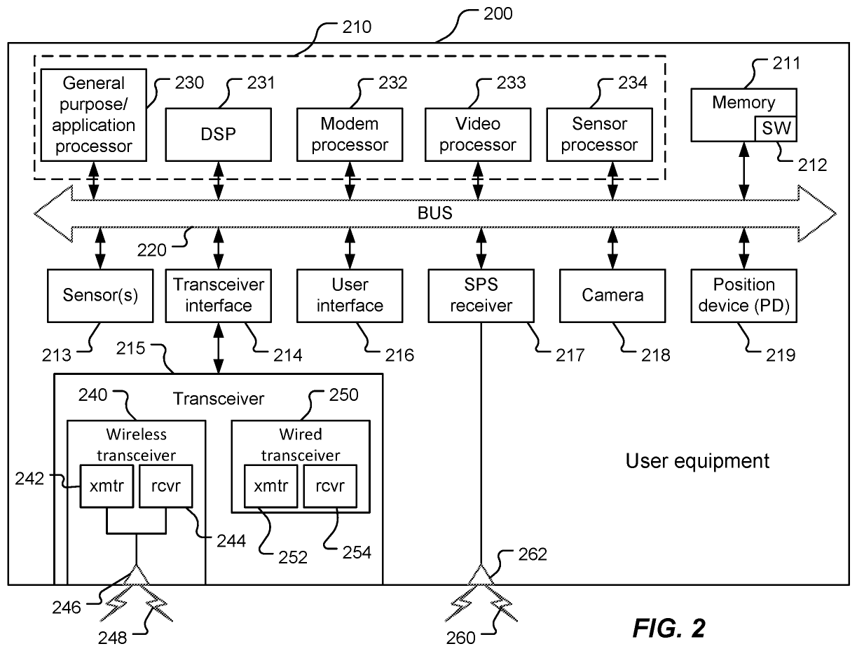

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

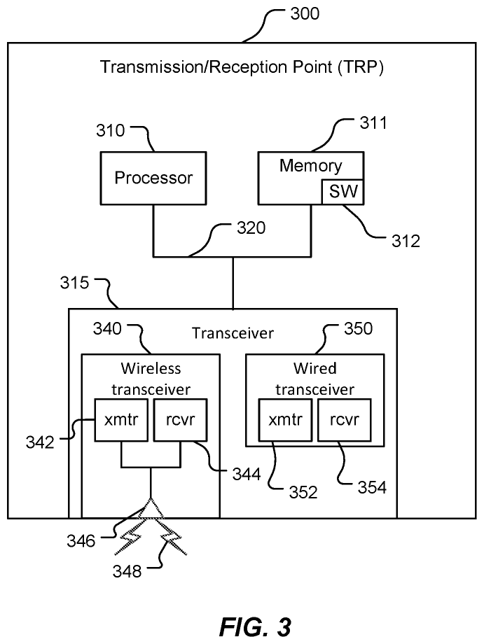

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions). In an example, a RSU may include some or all of the components of a TRP 300.

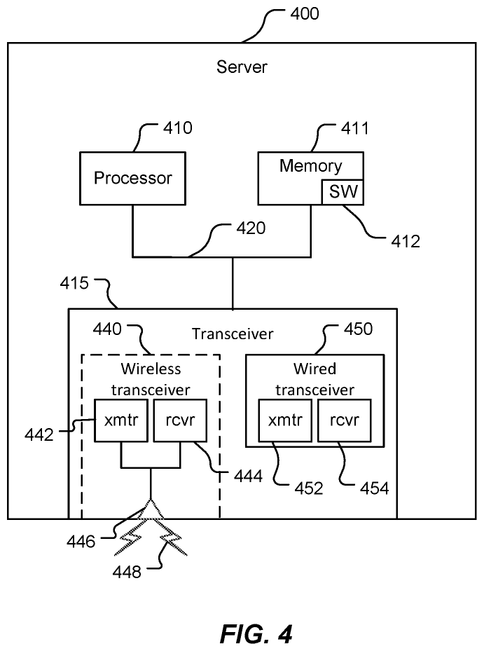

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

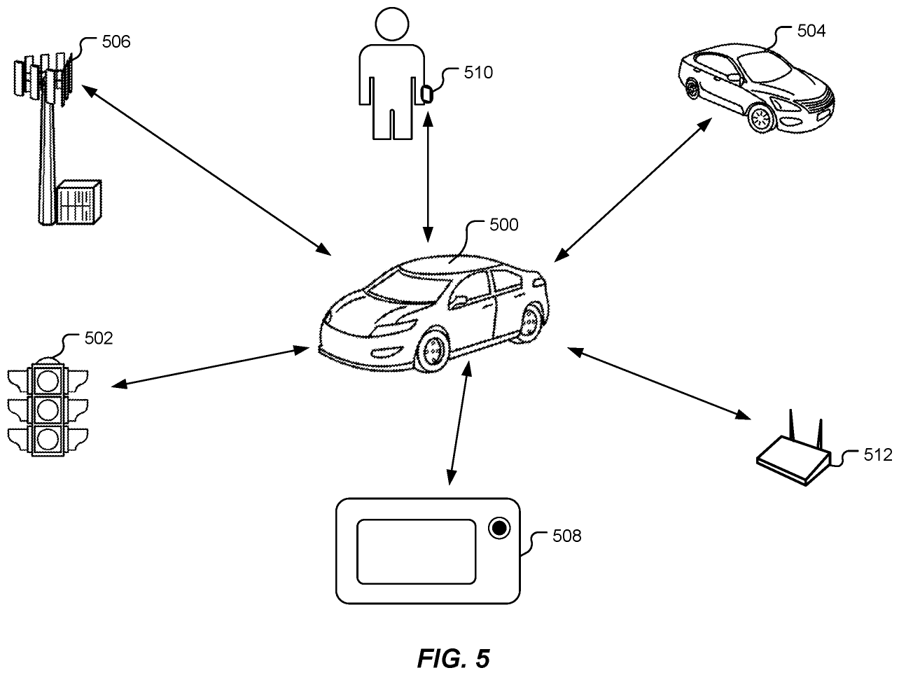

Referring to FIG. 5, a system diagram illustrating various entities configured to utilize V2X communication links is shown. In general, V2X communication involves passing information between a vehicle and any other entity that may affect or be affected by the vehicle. In an example, the ML models and/or improved safety margin perimeter profiles described herein may be provided via one or more V2X communication links including cellular and sidelinks (e.g., Uu and PC5 interfaces). A vehicle may include an OBU which may have some or all of the components of the UE 200, and the UE 200 is an example of an OBU. The OBU may be configured to communicate with other entities such as infrastructure (e.g., a stop light), pedestrians, other vehicles, cellular networks, and other wireless nodes. In an example, V2X may encompass other more specific types of communication such as Vehicle-to-Infrastructure (V2I), Vehicle-to Vehicle (V2V), Vehicle-to-Pedestrian (V2P), Vehicle-to-Device (V2D), and Vehicle-to-Grid (V2G).

Vehicle-to Vehicle (V2V) is a communication model designed to allow vehicles or automobiles to “talk” to each other, typically by having the automobiles form a wireless ad hoc network on the roads. Vehicle-to-Infrastructure (V2I) is a communication model that allows vehicles to share information with the components that support a road or highway system, such as overhead radio-frequency identification (RFID) readers and cameras, traffic lights, lane markers, streetlights, signage and parking meters, and so forth. Similar to V2V communication, V2I communication is typically wireless and bi-directional: data from infrastructure components can be delivered to the vehicle over an ad hoc network and vice versa. Vehicle-to-Pedestrian (V2P) communications involves a vehicle or automobile being able to communicate with, or identify a broad set of road users including people walking, children being pushed in strollers, people using wheelchairs or other mobility devices, passengers embarking and disembarking buses and trains, and people riding bicycles. Vehicle-to-Device (V2D) communications consists in the exchange of information between a vehicle and any electronic device that may be connected to the vehicle itself. Vehicle-to-Grid (V2G) communication may include a vehicle communicating with an electric power grid.

These more specific types of communication are useful for fulfilling various functions. For instance, Vehicle-to-Vehicle (V2V) is especially useful for collision avoidance safety systems, while Vehicle-to-Pedestrian (V2P) is useful for safety alerts to pedestrians and bicyclists. Vehicle-to-Infrastructure (V2I) is useful for optimizing traffic light control and issuing speed advisories, while Vehicle-to-Network (V2N) is useful for providing real-time traffic updates/routing and cloud services.

As referred to herein, V2X communications may include any of these more specific types of communication, as well as any communications between a vehicle and another entity that do not fall under one of these existing communications standards. Thus, V2X is a rather broad vehicular communication system.

V2X communication may be based on Institute of Electrical and Electronics Engineers (IEEE) 802.11 wireless local area network (WLAN) technology, LTE/5G NR PC5 and/or Uu interfaces, with vehicles and entities (e.g., V2X senders) communicating through an ad-hoc network that is formed as two V2X senders come into range with each other. Cellular-based solutions also exist, such as 5G NR-based V2X, which are capable of leveraging that technology to provide secure communication, precise positioning, and efficient processing. For example, C-V2X may utilize the communications system 100 described in FIG. 1 for V2X communication links.

One benefit of V2X communication is safety. For instance, V2X communication can enable a vehicle to communicate with its surroundings, such that the vehicle can increase driver awareness and provide driving assistance to the driver. For instance, the vehicle may be aware of other moving vehicles and pedestrians on the road. The vehicle can then communicate their locations to the driver, who may be unaware. If accidents are avoided this way, then the safety of the other vehicles and pedestrians on the road is improved. This is just one use case for V2X for improving safety. Other examples of V2X use cases directed to safety include forward collision warning, lane change warning/blind spot warning, emergency electric brake light warning, intersection movement assist, emergency vehicle approaching, road works warning, and platooning.

The V2X communication standard incorporates ADAS functions configured to assist a driver to make critical decisions when it comes to lane changing, speed changing, overtaking speed, and so forth. ADAS can assist driving in challenging conditions, such as bad weather, low lighting, low visibility, and so forth. ADAS can also be used for non-line-of-sight sensing, overtaking (e.g., passing other vehicles on the road), cooperative driving, and do not pass (DNP) alerts.

V2X communication standards may also provide assistance in different modes. A first V2X mode may be utilize to increase driver awareness. For example, the vehicle can use its knowledge of the positions of the various other vehicles on the road in order to provide the driver a bird's eye view of an intersection, or to provide the driver with see-through capability when driving behind a truck (e.g., the vehicle will visually display to the driver the other vehicles on the other side of the truck that are obscured by the truck). A second V2X mode may be configured to provide cooperative driving and collision avoidance. For example, V2X can be used for platooning to tightly group vehicles on the road by enabling those vehicles to communicate and accelerate/brake simultaneously. V2X can also be used for regulating vehicle speed or overtake negotiation, in which a vehicle is able to signal its intent to overtake other vehicles in order to secure the overtaking situation. A third V2X mode may be utilized by vehicles that are configured for autonomous driving.

In an example, a vehicle 500 may be able to communicate with infrastructure 502 (e.g., a traffic light) using Vehicle-to-Infrastructure (V2I) communication. In some embodiments, the vehicle 500 may be able to communicate with other vehicles on the road, such as vehicle 504, via Vehicle-to Vehicle (V2V) communication. The vehicle 500 may be able to communicate with a cellular station 506 via a cellular protocol such as the Uu interface. The vehicle 500 may include sensors such as cameras, radar/lidar and ultrasound to implement ADAS functions including safety margin perimeter profiles, such as keep distance (KD), automatic emergency breaking (AEB), lane support system (LSS), and other ADAS functions as described herein. The cellular station 506 may be a base station such as the gNB 110a, and may include some or all of the components of the TRP 300. In an example, the vehicle 500 may be able to communicate with device 508 via Vehicle-to-Device (V2D) communication. In some of such embodiments, the device 508 may be any electronic device that may be connected to the vehicle itself. For example, the device 508 may be a third party or on-board GPS navigation device, which the vehicle 500 can communicate with to obtain information available to the device 508. If the GPS navigation device had information regarding congested routes, traffic density, the location of other vehicles on the road with similar devices, and so forth, the vehicle 500 may be able to obtain all that information. In an example, the device 508 may include a user interface display, audio, and/or haptic components configured to provide alerts to a user.

In an example, the vehicle 500 may be able to detect a UE, or other wireless device, carried by a pedestrian 510 via Vehicle-to-Pedestrian (V2P) technology. For instance, the vehicle 500 may have a detection method such as cameras or sensors that allow the vehicle 500 to detect and confirm the presence of pedestrian 510 on the road. Pedestrian 510 may encompass a broad set of people, including people walking, children being pushed in strollers, people using wheelchairs or other mobility devices, passengers embarking and disembarking buses and trains, people riding bicycles, and so forth.

In an example, the vehicle 500 may be configured to communicate with a roadside unit (RSU) 512, or other networked devices such as a AP. The RSU may be disposed in high traffic areas and may be configured to provide improved safety margin perimeter profiles and/or ML models as described herein. The RSU 512 may include some or all of the components of the TRP 300. In general, a RSU is less capable than a TRP since the coverage area of the RSU is less than the TRP.

In some embodiments, the vehicle 500 and the other entities in FIG. 5, may also be able to receive information from a network or server, such as the server 400 (not shown in FIG. 5). The vehicle 500 may be able to communicate with the network and server to receive information about the locations and capabilities of infrastructure 502, vehicle 504, cellular stations 506, pedestrian 510, and the RSU 512 without having to communicate with those entities directly.

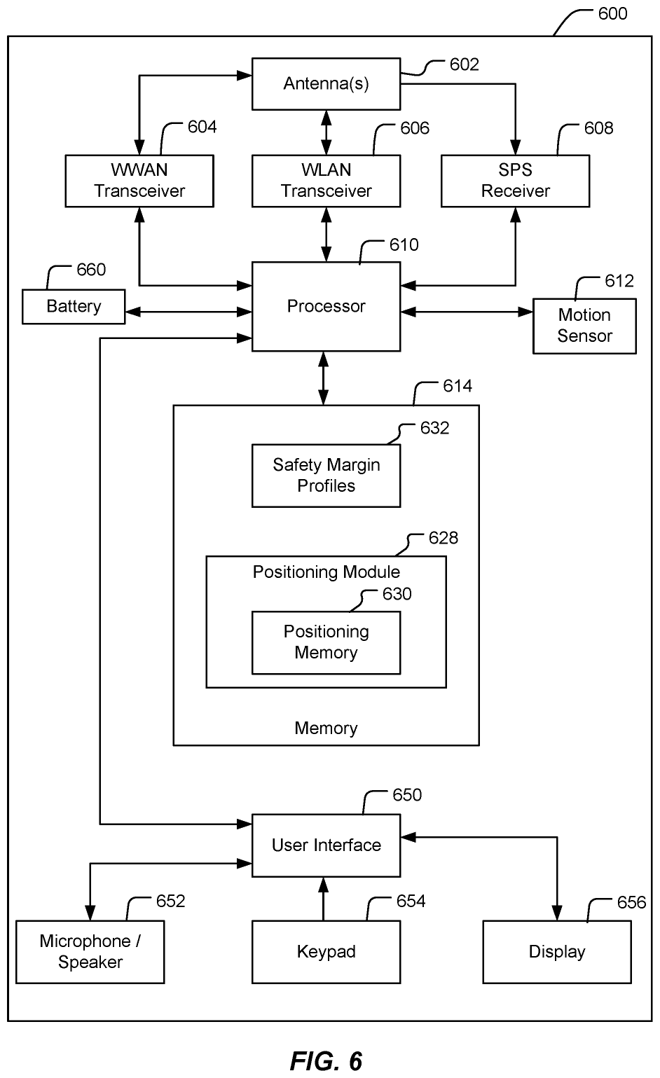

Referring to FIG. 6, an example mobile device which is capable of generating and implementing improved safety margin perimeter profiles is shown. FIG. 6 is a block diagram illustrating various components of an example mobile device 600. In an example, the mobile device 600 may have some or all of the components of the UE 200. The mobile device 600 may be an OBU or other electronic devices, such as the device 508 in FIG. 5. The mobile device 600 may be configured to communicate with elements in a V2X network as described in FIG. 5. A vehicle, such as the vehicle 500 with reference to FIG. 5, may have an in-vehicle display, such as display 656 described below, and on-board navigation computer, such as processor 610 described below. The features or functions illustrated in the example of FIG. 6 may be further subdivided into two or more of the features or functions illustrated in FIG. 6 may be combined.

The mobile device 600 may include one or more wireless wide area network (WWAN) transceiver(s) 604 that may be connected to one or more antennas 602. The WWAN transceiver 604 comprises suitable devices, hardware, and/or software for communicating with and/or detecting signals to/from WWAN access points and/or directly with other wireless devices within a network. In an example, the WWAN transceiver may be configured to communicate with the wireless communication system 100 described in FIG. 1.

The mobile device 600 may also include one or more wireless local area network (WLAN) transceivers (such as illustrated WLAN transceiver 606) that may be connected to one or more antennas 602. The WLAN transceiver 606 comprises suitable devices, hardware, and/or software for communicating with and/or detecting signals to/from WLAN access points and/or directly with other wireless devices within a network. In an example, the WLAN transceiver 606 may comprise a Wi-Fi (IEEE 802.11x) communication system suitable for communicating with one or more wireless access points. The WLAN transceiver 606 may comprise another type of local area network or personal area network (PAN). Additionally, any other type of wireless networking technologies may be used, for example, Ultra-Wide Band, Bluetooth, ZigBee, wireless USB, etc. As described above, V2X communication may include communication using WLAN transceiver 606 with various vehicles and/or entities.

A satellite positioning system (SPS) receiver 608 may also be included in the mobile device 600. The SPS receiver 608 may be connected to the one or more antennas 602 for receiving satellite signals. The SPS receiver 608 may comprise any suitable hardware and/or software for receiving and processing SPS signals. The SPS receiver 608 requests information and operations as appropriate from the other systems and performs the calculations for determining the position of the mobile device 600 using measurements obtained by any suitable SPS algorithm. In some embodiments, the mobile device 600 is within a vehicle (e.g., vehicle 500 in FIG. 5) and the determined position of the mobile device 600 can be used to track the vehicle as it travels along a route.

A motion sensor 612 may be coupled to a processor 610 to provide movement and/or orientation information, which is independent of motion data derived from signals, received by the WWAN transceiver 604, the WLAN transceiver 606 and the SPS receiver 608. The motion sensor 612 may utilize an accelerometer (e.g., a microelectromechanical systems device), a gyroscope, a geomagnetic sensor (e.g., a compass), an altimeter (e.g., a barometric pressure altimeter), and/or any other type of movement detection sensor. Moreover, the motion sensor 612 may include a plurality of different types of devices and combine their outputs in order to provide motion information. For example, the motion sensor 612 may use a combination of a multi-axis accelerometer and orientation sensors to provide the ability to compute positions in 2-D and/or 3-D coordinate systems. In some embodiments, the computed positions from the motion sensor 612 may be used with the calculated positions from the SPS receiver 608 in order to more accurately determine the position of the mobile device 600 and any associated vehicle containing the mobile device 600.

The processor 610 may be connected to the WWAN transceiver 604, WLAN transceiver 606, the SPS receiver 608 and the motion sensor 612. The processor 610 may include one or more microprocessors, microcontrollers, and/or digital signal processors that provide processing functions, as well as other calculation and control functionality. The processor 610 may also include memory 614 for storing data and software instructions for executing programmed functionality within the mobile device 600. The memory 614 may be on-board the processor 610 (e.g., within the same integrated circuit package), and/or the memory may be external memory to the processor and functionally coupled over a data bus.

A number of software modules and data tables may reside in memory 614 and be utilized by the processor 610 in order to manage communications, safety margin profiles, route planning, and positioning determination functionality. As illustrated in FIG. 6, memory 614 may include and/or otherwise receive a positioning module 628 and a map application capable of generating a map associated with a computed location determined by the positioning module 628, or additionally or alternatively, a map comprising a plurality of routes from, for example, a destination address and a source address. A positioning memory 630 may include map data associated with locations such as intersections, drive ways, road ways, parking areas, etc. which may include parameters to define features of the locations. A safety margin profiles module 632 may be configured to enable the generation of improved safety margin perimeter profiles as described herein. In an example, the safety margin profiles module 632 may include one or more look-up-tables (LUTs) including vehicle operational parameters and associated safety margin profiles. The safety margin profiles module 632 may include ML models, such as a NN, configured to receive vehicle operational parameters and output an improved safety margin profile. In an example, the mobile device 600 may be configured to utilize V2X communications to receive safety margin profile LUTs and/or ML models. Other signaling techniques may also be used. The memory contents as shown in FIG. 6 are examples, and as such the functionality of the modules and/or data structures may be combined, separated, and/or be structured in different ways depending upon the implementation of the mobile device 600. In an example, a battery 660 may be coupled to the processor 610, wherein the battery 660 may supply power to the processor 610 and various other modules and components located on the mobile device 600 through appropriate circuitry and/or under control of the processor 610.

The positioning module 628 can be capable of determining a position based on inputs from wireless signal measurements from WWAN transceiver 604, signal measurements WLAN transceiver 606, data received from SPS receiver 608, and/or data from motion sensor 612. For instance, the positioning module 628 may direct the processor 610 to take satellite signals from the SPS receiver 608 to determine the global position of the mobile device 600. This position of the mobile device 600 may then be mapped relative to the locations of the routes displayed in the navigation map. The accuracy of the position of the mobile device 600 may be further improved by taking data from neighboring devices or vehicles via the WWAN transceiver 604 and WLAN transceiver 606 (for example, using V2X communications), in order to determine the position of the mobile device 600 relative to neighboring devices or vehicles and make adjustments to the satellite-based position. Additionally, the accuracy of the position of the mobile device 600 may be further improved by taking data from the motion sensor 612, which will provide information about the distance between the mobile device 600 and surrounding objects or landmarks.

The map application can be capable of generating an image of a map of an area surrounding the position determined by the positioning module 628 above. Additionally or alternatively, the map application can be capable of generating an image of a map of an area surrounding any given position based on the map application receiving coordinates of a location. To generate the image, using the computed or received coordinates, the map application can access data from a map server (not illustrated) via, for example, WWAN transceiver 604 or WLAN transceiver 606.

While the modules shown in FIG. 6 are illustrated in the example as being contained in the memory 614, it is recognized that in certain implementations such procedures may be provided for or otherwise operatively arranged using other or additional mechanisms. For example, all or part of the positioning module 628 may be provided in firmware. Also, some aspects of positioning module 628 may be performed in WWAN transceiver 604.

The mobile device 600 may include a user interface 650, which provides any suitable interface systems, such as a microphone/speaker 652, keypad 654, and display 656 that allows user interaction with the mobile device 600. The microphone/speaker 652 provides for voice communication services using the WWAN transceiver 604 and/or the WLAN transceiver 606. The microphone/speaker 652 may be configured to provide audio-based navigation instructions. Although illustrated as a single device, it is understood that microphone/speaker 652 may comprise a separate microphone device and a separate speaker device. The keypad 654 comprises any suitable buttons for user input. The display 656 comprises any suitable display, such as, for example, a liquid crystal display, and may further include a touchscreen display for additional or alternative user input modes. The user interface 650 is illustrated as a hardware user interface, however, can also be understood to include a graphical user interface displayed on a touchscreen (for example, integrated with display 656) allowing output to a user and receipt of input from the user. Input from, and output to, a user can be mediated through the user interface 650 such that the mobile device, for example the processor 610 or other components, can receive user input from the user interface 650 and provide output to the user via the user interface 650.

The processor 610 may include forms of logic suitable for performing at least the techniques provided herein. For example, the processor 610 may obtain position or location information via one or more transceivers or sensors, such as the WWAN transceiver 604, WLAN transceiver 606, the SPS receiver 608, and or the motion sensor 612. Using this location information, the processor 610 may utilize the positioning module 628 and the map application in order to map out the location of the mobile device 600 (and the vehicle the mobile device 600 is in) relative to one or more routes between a source address and a destination address in a navigation map. The map application may include intersection classification information, or other feature information, which may be used to generate improved safety margin perimeter profiles. The processor 610 may then cause the navigation map along with the one or more routes to be displayed in the display 656. The navigation map can also be provided in the context of the user interface 650, such that a user can select a specific route presented through the navigation map.

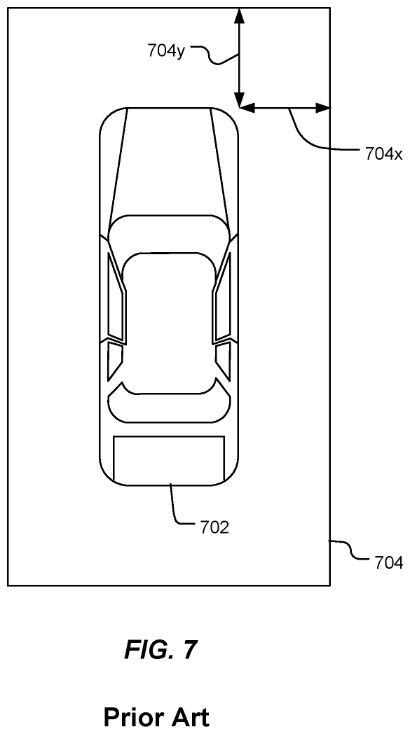

Referring to FIG. 7, an example prior art safety margin perimeter is shown. In some ADAS systems, a method used to remove false alarms in a collision avoidance system such as autonomous emergency braking (AEB) and lane support system (LSS) is to add a boxy-shape symmetrical perimeter around a vehicle 702 as a safety margin 704. The safety margin 704 may extend in two dimensions, such as along an x-axis 704x and a y-axis 704y from the vehicle 702. In operations, an AEB system may be configured to brake to avoid objects within the safety margin 704. A large safety margin will result in more brake interventions, while a small safety margin will result in less brake interventions but also more collisions.

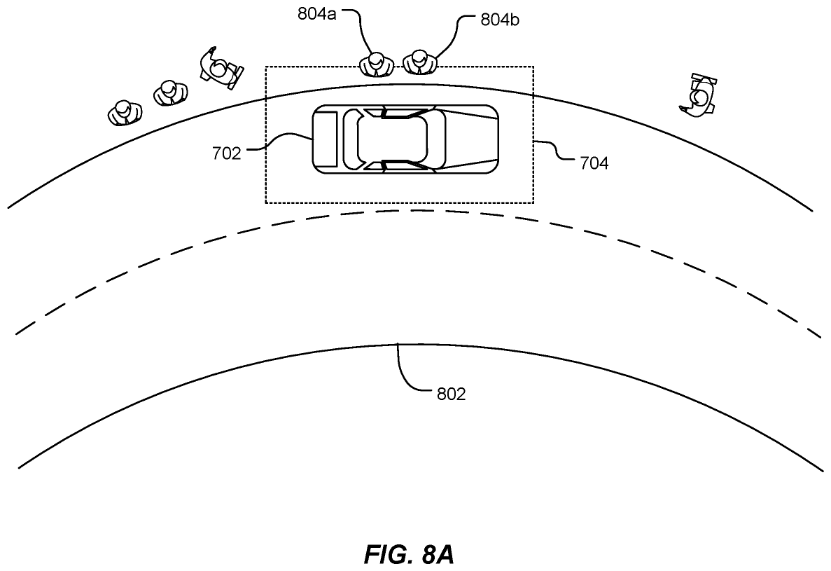

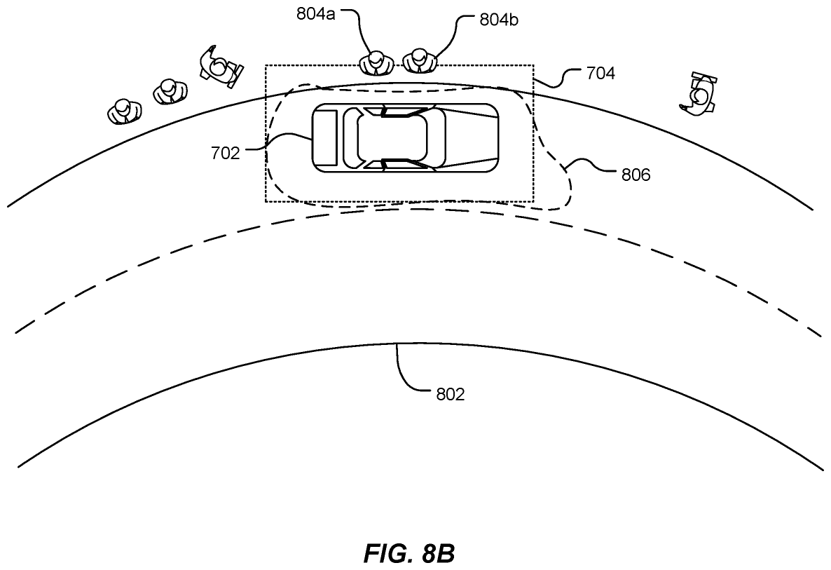

Referring to FIGS. 8A and 8B, an example use case of an improved safety margin perimeter profile is shown. A pedestrian heavy area, such as the entrance to a building (e.g., hotel, theater, school, airport terminal, etc.), intersections, shopping areas, etc. may require vehicles to operate in proximity to pedestrians and other roadside objects. For example, a hotel entrance may have a circular drive 802 to enable the vehicle 702 to pick-up pedestrians from a waiting area. As depicted in FIG. 8A, a first pedestrian 804a and a second pedestrian 804b are located within the safety margin 704 and thus would activate a braking response from the AEB system in the vehicle 702. As shown, the AEB requires a smaller safety margin on the left side of the vehicle 702 compared to the right side to reduce false alarms due to the pedestrians 804a, 804b standing close to vehicle 702. In addition, larger margins may be needed to the right side of the vehicle 702 for any crossing vulnerable road users (VRUs). A problem with the prior art symmetric safety margins is that shrinking the size of the safety margin 704 may reduce the number of false positive detections, but it may degrade the collision avoidance system performance.

In an example, referring to FIG. 8B, an improved safety margin profile 806 may be generated based on different input factors for a situation/scenario and extracted using neural networks (NN) and other machine learning (ML) techniques. Example input factors to train a ML model for a base margin profile may include vehicle speed, acceleration, steering angle, heading angle. Other inputs may be used. The output of the ML model may be a non-symmetrical safety margin to accommodate specific use cases such as the circular drive 802. As depicted in FIG. 8B, the improved safety margin profile 806 is narrower on the left of the vehicle 702 and extends forward to the right side of the vehicle 702. Other profiles may be generated based on the ML training. The ML models and resulting non-symmetrical safety margin perimeters profiles may be trained based on a combination of real-life traffic data, synthetic data, and controlled test-track scenarios. In an example, the base trained margin profile may be constrained to scenarios where break intervention is required (e.g., car-to-car breaking (CCR-B) scenarios).

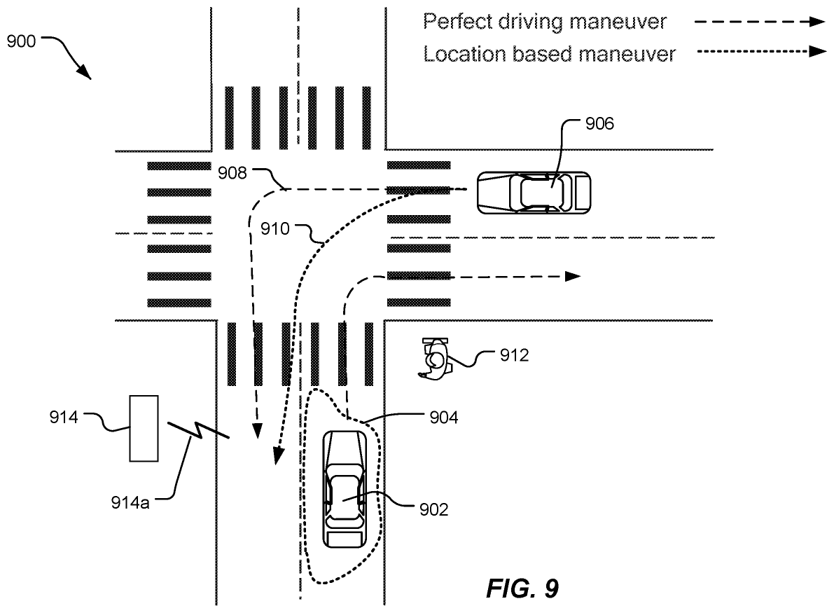

Referring to FIG. 9, an example use case for a location based safety margin perimeter profile is shown. In an example, due to different driving behaviors in different locations/countries, an extra input factor of location may be utilized as an input to a NN as an improvement to a base trained safety margin profile. Thus, location-based safety margin perimeters may be extracted based on training a NN network based on local data. For example, an intersection 900 may be locate at a known location (e.g., neighborhood, city, county, country, etc.), and a first vehicle 902 and a second vehicle 906 may be waiting to transit through the intersection 900. A pedestrian 912 may also be in the process of crossing the intersection 900. In some locations (e.g., countries), when the second vehicle 906 makes a left-turn through the intersection, the second vehicle 906 may follow a proper driving course 908. In other locations, however, the second vehicle 906 may make the left-turn with an aggressive driving course 910 which is likely to trigger the collision avoidance system on the first vehicle 902 by penetrating the safety margin perimeter 904. In this location (e.g., country), reducing a left portion of the safety margin perimeter 904 of the first vehicle 902 may help reduce the number of brake interventions. An asymmetric safety margin perimeter, such as the safety margin perimeter 904, may be output from a NN to account for local driving customs (e.g., sharp left turns) as well as account for potential pedestrian traffic by not reducing a right portion of the safety margin perimeter (e.g., to account for pedestrian traffic, such as the pedestrian 912).

The location of the use case in FIG. 9 is not limited to countries. In an example, intersection features may be included in high definition map data received by the first vehicle 902 (e.g., via an onboard unit (OBU), mobile device, or other navigation system), and the intersection features may be used as input to the NN. The intersection features may be used with other geographic and non-geographic information. For example, country/city information may be used in combination with intersection feature information to train a NN. Time of day, day of week, and date information (e.g., holiday, special events, etc.) may be used as inputs to train a NN for different safety margin perimeters. In an example, a roadside unit (RSU) 914 disposed proximate to an intersection (or other location), may be configured to provide safety margin perimeters and/or NN data/models to enable a vehicle to compute safety margin perimeters for proximate locations (e.g., intersections, parking lots, driveways, etc.). The RSU 914 may include some or all of the components of the TRP 300, and may be configured to utilize a communications link 914a such as Uu or PC5 to communicate with the first vehicle 902. Referring to the hotel drive use case in FIGS. 8A and 8B, a network node associated with the location (not shown) may be configured to communicate with a V2X network and may provide safety margin perimeter information and/or NN models to proximate vehicles to enable the vehicles to utilize asymmetric safety margin profiles that are beneficial for that specific area.

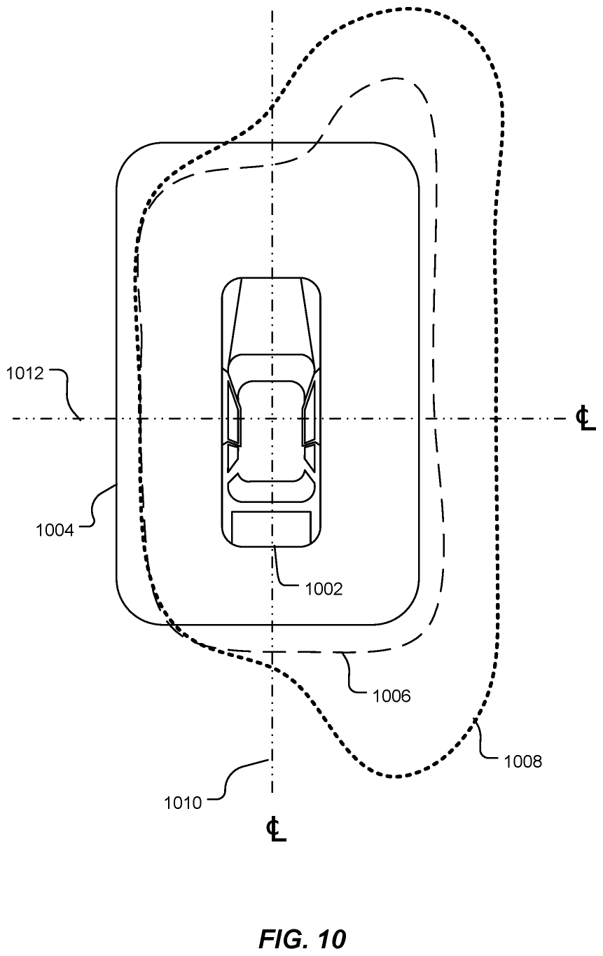

Referring to FIG. 10, a diagram of example safety margin perimeter profiles is shown. The number and shapes of the perimeter profiles are examples, and not limitations, as ML learning models may be configured to output different perimeter profiles based on different operational inputs. A vehicle 1002 may include a mobile device 600, or other OBU, configured to generate safety margin perimeter profiles base on vehicle parameters, location information and/or other contextual variables associated with ADAS functionality. A first safety margin perimeter 1004 may be a symmetrical shape around the vehicle 1002. The dimensions of the first safety margin perimeter 1004 may be a function of a speed of the vehicle 1002. A second safety margin perimeter 1006 may be associated with urban roadway driving where the risk potential of a crossing vehicle is increased. A third safety margin perimeter 1008 may be associated with heavy traffic areas and/or areas with bike lanes where pedestrian traffic may be proximate to the right side of the vehicle 1002. Other safety margin perimeter profiles may be implemented for other scenarios. The second safety margin perimeter 1006 and the third safety margin perimeter 1008 are examples of asymmetric safety margin perimeter profiles around the vehicle 1002. As used herein, an asymmetric safety margin perimeter profile means a perimeter profile that is not identical on both sides of a centerline of the vehicle. As depicted in FIG. 10, the second and third perimeters 1006, 1008 are not identical on both sides of a first centerline 1010 running through the length (e.g., front to back) of the vehicle 1002. Other asymmetric perimeters may be unequal based on a second centerline 1012 running left to right (e.g., the width) through the vehicle 1002. A ML model, such as a NN, may be trained to output different safety margin perimeters based on operational, location based, and other parameters associated with ADAS operations. Other factors, such as a driver's age, experience level, disability status, vehicle features (e.g., blind spots), road conditions, weather (e.g., snow and rain fall, fog, etc.), and other factors which may impact the ability of a driver to operate a vehicle, and the ability of a vehicle to respond to driver input (e.g., braking distance due to road conditions). In a use case, the utilization of the vehicle may be used as a factor. For example, a livery or taxi may utilize tighter safety margin perimeters to enable operations that are closer to pedestrians (e.g., to pick up passengers). The status of the taxi (e.g., available/with passenger) may also be used such that standard safety margins may be applied when the taxi is transporting passengers to a destination.

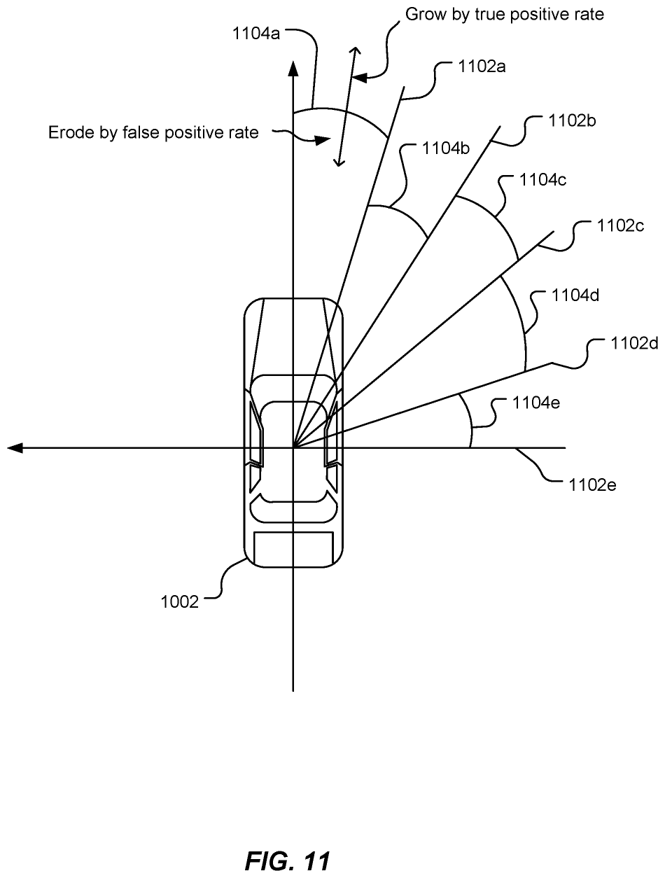

Referring to FIG. 11, a first example process for obtaining an asymmetric safety margin perimeter profile is shown. The area around the vehicle 1002 may be discretize into n number of sections. For example, the area may include sections 1102a-1102e as depicted in FIG. 11. Two main constrains may be applied to each of the sections based on training data obtained by test vehicles or other performance models. The first constraint is to maximize the true positive (tp) rate:

$$Max {\sum }_{i = 0}^{n} {∝}_{i} Log ( {P}_{{tp}_{i}} ) \qquad ( 1 )$$

The second constraint on the analysis of the training data is to keep the false alarm (fa) rate below a threshold value k.

$${P}_{fa} < k \qquad ( 2 )$$

Where ∝ᵢ is a factor to use to impact the true positive for each section where it needs to be overweighed (e.g., around b-pillar of vehicle); and

k is the false alarm threshold.

The resulting distances which satisfy both constraints in each section may be used to create a safety margin profile perimeter. For example, the resulting distances 1104a-1104e may be used to create the safety margin perimeters 1006, 1008 as depicted in FIG. 10.

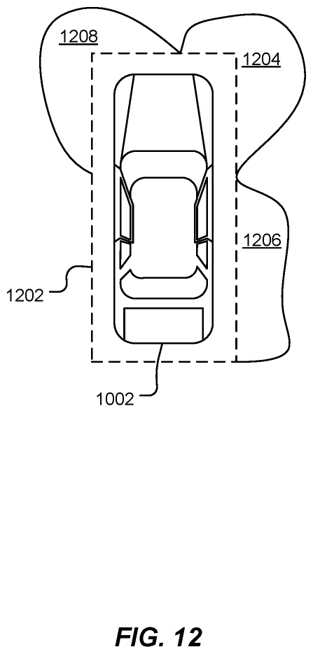

Referring to FIG. 12, a second example process for obtaining an asymmetric safety margin perimeter profile is shown. In this example, the training data may be analyzed based on creating defined areas around the vehicle 1002. The training may start with a base perimeter 1202 as a minimum possible safety margin. The two constraints of equations (1) and (2) may be applied to defined areas, such as a first area 1204, a second area 1206, and a third area 1208. Other areas may also be designed based on the test data to improve the true positive (tp) rate and reduce the false alarm (fa) rate.

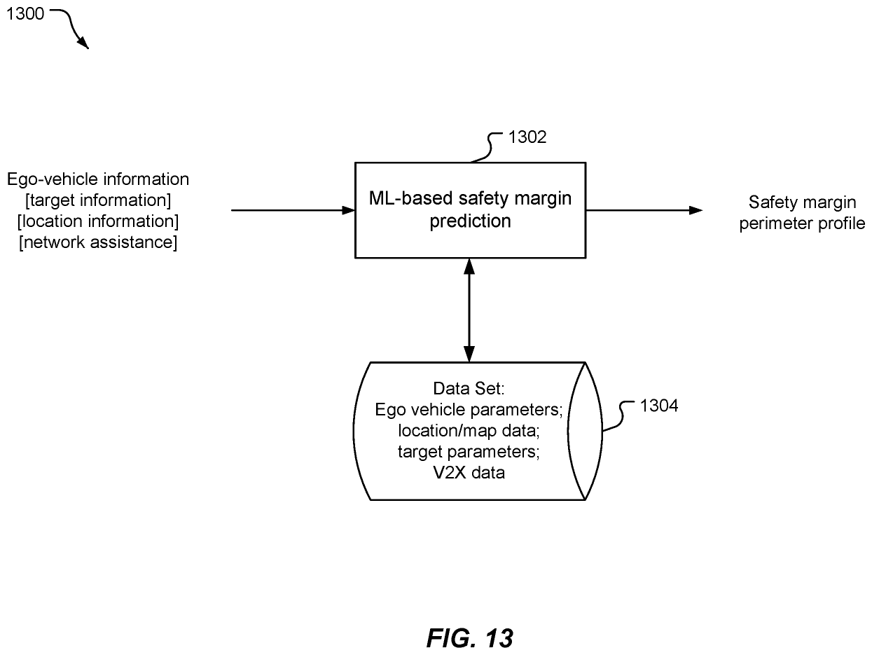

Referring to FIG. 13, an example machine learning (ML) based safety margin perimeter prediction module 1300 is shown. A ML based safety margin prediction model 1302 may be trained to learn relationships between vehicle, operator, environmental, and other input parameters to predict a safety margin perimeter. Additional data may also be used with the model 1302. For example, a data set 1304 may also include ego vehicle parameters, location/map information, target parameters, V2X information (e.g., provided by a network), as well as operator information (e.g., age, experience, etc.) and other sensor information, such as information obtained with other sensors on a vehicle, such as a camera, an infra-red (IR) sensor, a lidar, a microphone (acoustic input), etc. Such information may be added to the data set 1304 as training data that may be used to train (or re-train) the ML-based safety margin prediction model 1302. In an example, the size of the data set 1304 may be very large, and it may not be feasible to share the entire dataset with a OBU on a vehicle, such as the mobile device 600. In some cases, rather than share the data set 1304, a more practical approach may be to train the safety margin prediction model 1302 as a neural network (NN) using the data set 1304, and then share the neural network model and the parameters (e.g., weights and the like) for the trained model with the mobile device 600. The mobile device may then use the trained NN to predict safety margin perimeter profiles based on ego-vehicle information, and other inputs.

Such a machine learning model may be trained using various techniques to learn how to generate a safety margin perimeter profile. Given ego-vehicle information, and other input information (e.g., target, location, network assistance, user, environmental, etc.), the trained machine learning model may be configured to predict a safety margin and output a safety margin perimeter profile, such as the profiles described in FIGS. 8B-12.

In an example, the safety margin prediction model 1302 may be trained using supervised learning techniques in which an input data set of ego-vehicle information, location information, and other parameters may be used to train the machine learning model to optimize the relationship between the true positive (tp) and false alarm (fa) rates as described in equations (1) and (2), and generate a safety margin perimeter profile.

The safety margin prediction model 1302 may be based on other machine learning algorithms and training methods. For example, supervised learning algorithms, unsupervised learning algorithms, reinforcement learning algorithms, deep learning algorithms, artificial neural network algorithms, or other type of machine learning algorithms may be used. For example, the machine learning may be performed using a deep convolutional network (DCN). DCNs are networks of convolutional networks, configured with additional pooling and normalization layers. DCNs have achieved state-of-the-art performance on many tasks. DCNs may be trained using supervised learning in which both the input and output targets are known for many examples and are used to modify the weights of the network by use of gradient descent methods. DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

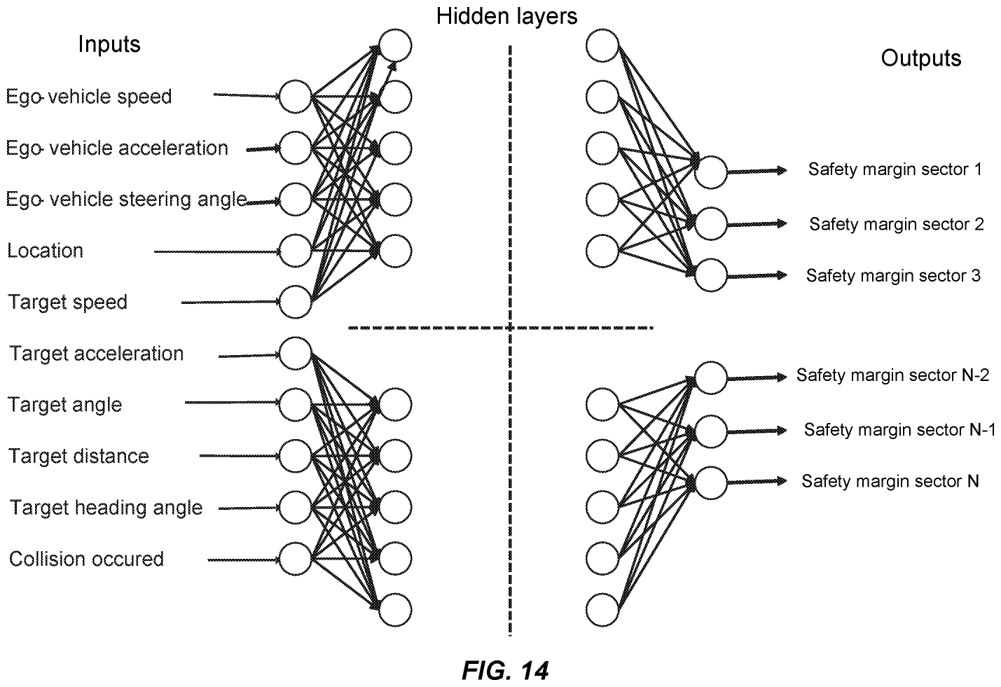

In an example, referring to FIG. 14, the machine learning may be performed using a neural network. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In an example, different types of artificial neural networks may be used to implement machine learning, such as recurrent neural networks (RNNs), multilayer perceptron (MLP) neural networks, convolutional neural networks (CNNs), and the like. RNNs work on the principle of saving the output of a layer and feeding this output back to the input to help in predicting an outcome of the layer. In MLP neural networks, data may be fed into an input layer, and one or more hidden layers provide levels of abstraction to the data. Predictions may then be made on an output layer based on the abstracted data. MLPs may be particularly suitable for classification prediction problems where inputs are assigned a class or label. Convolutional neural networks (CNNs) are a type of feed-forward artificial neural network. Convolutional neural networks may include collections of artificial neurons that each has a receptive field (e.g., a spatially localized region of an input space) and that collectively tile an input space. Convolutional neural networks may be trained to recognize a hierarchy of features. Computation in convolutional neural network architectures may be distributed over a population of processing nodes, which may be configured in one or more computational chains. These multi-layered architectures may be trained one layer at a time and may be fine-tuned using back propagation.

Aspects of the present disclosure provide techniques for generating safety margin perimeter profiles using machine learning models. Inputs as described herein, and as listed in FIG. 14 (for example), may be used to generate safety margin sectors or areas to generate safety margin perimeter profiles.

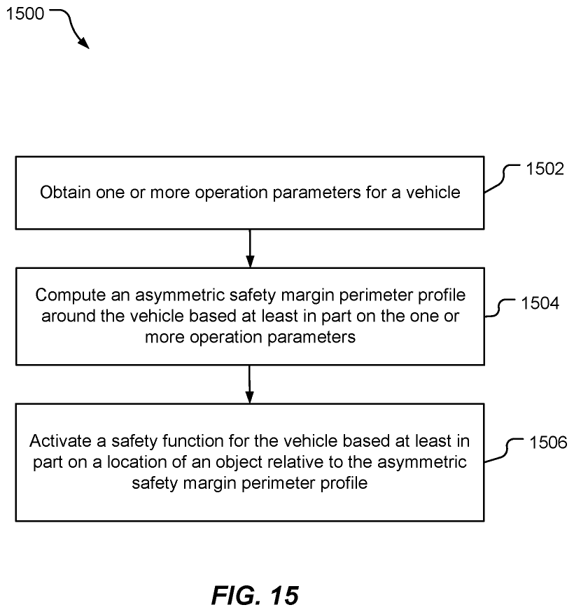

Referring to FIG. 15, with further reference to FIGS. 1-14, a method 1500 for activating an advanced driving assistance system (ADAS) function includes the stages shown. The method 1500 is, however, an example and not limiting. The method 1500 may be altered, e.g., by having stages added, removed, rearranged, combined, performed concurrently, and/or having single stages split into multiple stages.

At stage 1502, the method includes obtaining one or more operational parameters for a vehicle. A mobile device, such as the UE 200 or the mobile device 600, including a processor 610 and motion sensor 612, are means for obtaining operational parameters. The one or more operational parameters may be based on ego vehicle parameters such as a speed value, an acceleration value, a steering angle value, and other factors associated with defining a safety margin. Other operational parameters may be location information including specific roadway information (e.g., map data, intersection characteristics). In an example, the operational parameters may include target information (e.g., nearby vehicles and pedestrians) obtained by vehicle sensors such as radar and cameras. The operational parameters may include vehicle operator parameters such as age and/or experience level (e.g., student driver, provisional license, etc.), and environmental and/or roadway conditions. These operational parameters are examples, and not limitations, as other parameters may be used as inputs to ML models and/or fields in LUTs to generate a safety margin perimeter profile.

At stage 1504, the method includes computing an asymmetric safety margin perimeter profile around the vehicle based at least in part on the one or more operational parameters. The mobile device, including the processor 610 and the safety margin profiles module 632, is a means for computing asymmetric safety margin perimeter profiles. In an example, the one or more operational parameters obtained at stage 1502 may be used as a criteria for a LUT containing a plurality of asymmetric safety margin perimeter profiles, such as the second and third safety margin perimeters 1006, 1008 depicted in FIG. 10. In an example, the vehicle may include a NN model configured to receive the one more operational parameters and output an asymmetric safety margin perimeter profile. The safety margin perimeter profiles may be based on maximizing the true positive (tp) rate and keeping the false alarm (fa) rate below a threshold value, as described in equations (1) and (2), for different sectors or other areas around the vehicle. The NN models, and resulting safety margin perimeter profiles, may be trained based on a combination of real-life traffic data, synthetic data, and controlled test-track scenarios.

At stage 1506, the method includes activating a safety function for the vehicle based at least in part on a location of an object relative to the asymmetric safety margin perimeter profile. The mobile device, including the processor 610, is a means for activating the safety function. The safety function may be a ADAS function such as AEB and LSS. Other safety functions may also be activated based on the safety function perimeter. In an example, the safety function may be activated when an object is within the safety margin perimeter profile. In an example, vehicle sensors such as radar and cameras may be configured to obtain object trajectory information (i.e., based on an object's motion) and compute a closest point of approach (CPA) based on the object trajectory and a trajectory of the vehicle. A safety function may be activated if the (CPA) is within the safety margin perimeter profile. Other vehicle functions may also be activated based on the relative location of an object in view of the asymmetric safety margin perimeter profile.

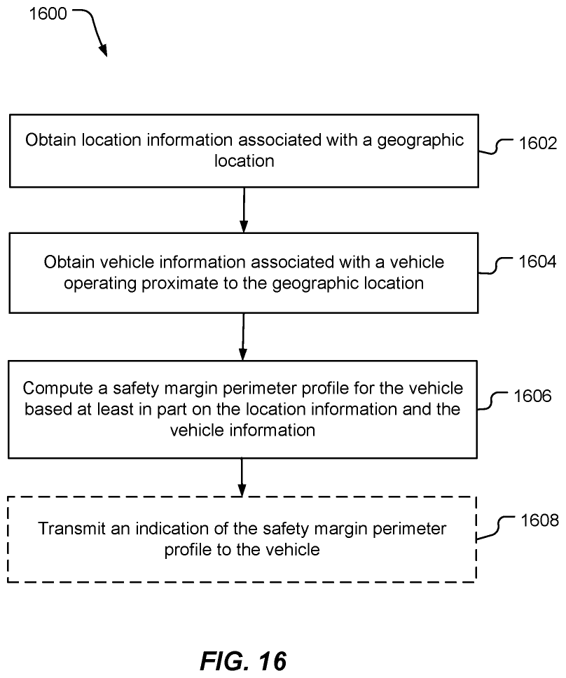

Referring to FIG. 16, with further reference to FIGS. 1-14, a method 1600 for computing a safety margin profile perimeter includes the stages shown. The method 1600 is, however, an example and not limiting. The method 1600 may be altered, e.g., by having stages added, removed, rearranged, combined, performed concurrently, and/or having single stages split into multiple stages. For example, transmitting an indication of the safety margin perimeter profile to a vehicle at stage 1608 is optional.

At stage 1602, the method includes obtaining location information associated with a geographic location. A mobile device 600 or a UE 200, including the processors 210 and the transceiver 215, are means for obtaining location information. In an example, a vehicle with an OBU (e.g., UE 200, mobile device 600) may be configured to receive map data from a communication network. The map data may include location information such as country, county, city, coordinates and/or other labels associated with a geographic location. The vehicle may include a navigation system (e.g., SPS receiver 608) configured to obtain location information based on satellite navigation signals. Other navigation techniques, such as terrestrial positioning methods using the communication system 100 may also be used to obtain location information. In an example, the location information may include map information including one or more parameters to define a particular geographic area such as an intersection, roadway, drive way, parking structure, etc. The one or more parameters may include lane and traffic flow descriptions, vehicle and pedestrian route information, or other descriptions which may be utilized for generating a safety margin perimeter profile. In an example, V2X communication links (e.g., Uu, PC5) may be used to provide location information to a vehicle.

At stage 1604, the method includes obtaining vehicle information associated with a vehicle operating proximate to the geographic location. The mobile device 600, including the processor 610 and the motion sensor 612, is a means for obtaining vehicle information. As used herein, operating proximate to the geographic location includes operating within the geographic area. The mobile device 600 may be configured to determine operational parameters from a vehicle such as speed, acceleration, and steering angle based on inputs from one or more sensors in the vehicle and/or within the mobile device 600 (e.g., accelerometers, gyroscopes, etc.). The vehicle information may include vehicle information such as make, model, year of manufacture, and/or a vehicle identification number (VIN). The vehicle information may also include target information obtained by on-board sensors such as radar, lidar, and cameras. The vehicle information may also include environmental information such as the level of ambient light, weather conditions, relative location of the sun (e.g., glare associated with low sun angles), or other environmental factors which may impact the operation of a vehicle. The vehicle information may include parameters associated with a user/driver, such as an experience level (e.g., age, date of license), and hours of continuous operation (e.g., potential driver fatigue). Some ADAS equipped vehicles may include operator sensors configured to track the attention level of a driver and the vehicle information may include parameters associated with the driver's current attention level.

At stage 1606, the method includes computing a safety margin perimeter profile for the vehicle based at least in part on the location information and the vehicle information. The mobile device 600, including the processor 610 and safety margin profiles module 632, is a means for computing safety margin perimeter profiles. In an example, the mobile device 600 may include one or more LUTs including safety margin profiles associated with the location information obtained at stage 1602 and the vehicle information obtained at 1604. For example, the second safety margin perimeter 1006 may be associated (e.g., linked to data fields) to a first location and a first vehicle information, and the third safety margin perimeter 1008 may be associated with the first location and a second vehicle information. LUTs may include other combinations of location and vehicle information and additional safety margin perimeter profiles. In an example, the mobile device may include a ML model, such as the NN depicted in FIG. 14, configured to receive the location and vehicle information and output a safety margin profile. The ML model may be provided to the mobile device 600 via a network entity, such as an external client 130 via the communication system 100. V2X technology may also be used to provide ML models to vehicles. In a use case, a RSU 914 may be configured to provide ML models to vehicles operating in an area. For example, a RSU at a toll booth station may provide ML model information to enable a vehicle to generate asymmetric safety margin perimeter profiles while operating near the toll booths as well as along the toll road. Other areas may be defined. Thus, V2X technology may be used to provide ML models to enable vehicles operating in the defined areas to generate safety margin profiles based on vehicle parameters. The safety margin perimeter profile may be configured to meet scenarios where brake intervention is required in combination with the geographic location obtained at stage 1602.

At stage 1610, the method optionally includes transmitting an indication of the safety margin perimeter profile to the vehicle. A TRP 300, including the processor 310 and the transceiver 315, is a means for transmitting the indication of the safety margin perimeter. The method 1600 may be performed locally (e.g., by a vehicle) and remotely (e.g., by a network entity). In a use case, a vehicle may be configured to provide location and vehicle information to a remote network entity such as a server 400 or other station (e.g., RSU 914), and the remote network entity may be configured to compute the safety margin perimeter profile based on the received location and vehicle information. In a use case, a network entity (e.g., the LMF 120) may be configured to determine location information for a vehicle and provide indications of safety margin profiles (e.g., LUTs, NNs or other ML models) to a vehicle based at least in part on the location information. The vehicle may then utilize the received indications in combination with vehicle information to compute safety margin profiles. In an example, the network entity may be configured to receive vehicle information (e.g., user ID, VIN, etc.) and provide a safety margin perimeter profile to a vehicle. The stages of the method 1600 may be performed by other entities in a V2X network.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA. AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method for activating an advanced driving assistance system (ADAS) function, comprising: obtaining one or more operation parameters for a vehicle; computing an asymmetric safety margin perimeter profile around the vehicle based at least in part on the one or more operation parameters; and activating a safety function for the vehicle based at least in part on a location of an object relative to the asymmetric safety margin perimeter profile.

Clause 2. The method of clause 1 wherein the asymmetric safety margin perimeter profile is not identical on both sides of a centerline running a length of the vehicle.

Clause 3. The method of clause 1 wherein the asymmetric safety margin perimeter profile is not identical on both sides of a centerline running a width of the vehicle.

Clause 4. The method of clause 1 wherein the one or more operation parameters include an ego vehicle parameter.

Clause 5. The method of clause 4 wherein the ego vehicle parameter includes a speed value, an acceleration value, a steering angle value, or combinations thereof.

Clause 6. The method of clause 1 wherein the one or more operation parameters includes location information.

Clause 7. The method of clause 1 wherein the one or more operation parameters includes an indication of an experience level of an operator of the vehicle.

Clause 8. The method of clause 1 wherein the one or more operation parameters includes an indication of an environmental condition proximate to the vehicle.

Clause 9. The method of clause 1 wherein the computing the asymmetric safety margin perimeter profile around the vehicle includes providing the one or more operation parameters as an input to a neural network configured to output the asymmetric safety margin perimeter profile.

Clause 10. The method of clause 9 further comprising receiving the neural network via a wireless communication link.

Clause 11. The method of clause 1 wherein the safety function is one of an autonomous emergency braking (AEB) system or a lane support system (LSS).

Clause 12. A method for computing a safety margin profile perimeter for a vehicle, comprising: obtaining location information associated with a geographic location; obtaining vehicle information associated with the vehicle operating proximate to the geographic location; and computing a safety margin perimeter profile for the vehicle based at least in part on the location information and the vehicle information.

Clause 13. The method of clause 12 wherein in the safety margin perimeter profile is asymmetric relative to a centerline of the vehicle.

Clause 14. The method of clause 12 wherein the location information is an identification of a country and the geographic location includes an area defined by a border of the country.

Clause 15. The method of clause 12 wherein the location information includes map information configured to define the geographic location.

Clause 16. The method of clause 15 wherein the geographic location includes an intersection, a roadway, a driveway, a building, a parking area, or combinations thereof.

Clause 17. The method of clause 12 wherein the vehicle information include one or more ego vehicle parameters.

Clause 18. The method of clause 17 wherein the one or more ego vehicle parameters include a speed value, an acceleration value, a steering angle value, or combinations thereof.

Clause 19. The method of clause 12 wherein the vehicle information includes an indication of an experience level of an operator of the vehicle.

Clause 20. The method of clause 12 wherein the vehicle information includes an indication of an environmental condition proximate to the vehicle.

Clause 21. The method of clause 12 wherein the computing the safety margin perimeter profile for the vehicle includes providing the location information and the vehicle information as inputs to a neural network configured to output the safety margin perimeter profile.

Clause 22. The method of clause 21 further comprising receiving the neural network via a wireless communication link.

Clause 23. The method of clause 12 further comprising transmitting an indication of the safety margin perimeter profile to the vehicle.

Clause 24. An apparatus, comprising: at least one memory; at least one processor communicatively coupled to the at least one memory and configured to: obtain one or more operation parameters for a vehicle; compute an asymmetric safety margin perimeter profile around the vehicle based at least in part on the one or more operation parameters; and activate a safety function for the vehicle based at least in part on a location of an object relative to the asymmetric safety margin perimeter profile.

Clause 25. The apparatus of clause 24 wherein the asymmetric safety margin perimeter profile is not identical on both sides of a centerline running a length of the vehicle.

Clause 26. The apparatus of clause 24 wherein the asymmetric safety margin perimeter profile is not identical on both sides of a centerline running a width of the vehicle.

Clause 27. The apparatus of clause 24 wherein the one or more operation parameters include an ego vehicle parameter.

Clause 28. The apparatus of clause 27 wherein the ego vehicle parameter includes a speed value, an acceleration value, a steering angle value, or combinations thereof.

Clause 29. The apparatus of clause 24 wherein the one or more operation parameters includes location information.

Clause 30. The apparatus of clause 24 wherein the one or more operation parameters includes an indication of an experience level of an operator of the vehicle.

Clause 31. The apparatus of clause 24 wherein the one or more operation parameters includes an indication of an environmental condition proximate to the vehicle.

Clause 32. The apparatus of clause 24 wherein the at least one processor is further configured to provide the one or more operation parameters as an input to a neural network configured to output the asymmetric safety margin perimeter profile.

Clause 33. The apparatus of clause 32 further comprising at least one transceiver communicatively coupled to the at least one processor, wherein the at least one processor is further configured to receive the neural network via a wireless communication link.

Clause 34. The apparatus of clause 24 wherein the safety function is one of an autonomous emergency braking (AEB) system or a lane support system (LSS).

Clause 35. An apparatus, comprising: at least one memory; at least one transceiver; at least one processor communicatively coupled to the at least one memory and the at least one transceiver, and configured to: obtain location information associated with a geographic location; obtain vehicle information associated with a vehicle operating proximate to the geographic location; and compute a safety margin perimeter profile for the vehicle based at least in part on the location information and the vehicle information.

Clause 36. The apparatus of clause 35 wherein in the safety margin perimeter profile is asymmetric relative to a centerline of the vehicle.

Clause 37. The apparatus of clause 35 wherein the location information is an identification of a country and the geographic location includes an area defined by a border of the country.

Clause 38. The apparatus of clause 35 wherein the location information includes map information configured to define the geographic location.

Clause 39. The apparatus of clause 38 wherein the geographic location includes an intersection, a roadway, a driveway, a building, a parking area, or combinations thereof.

Clause 40. The apparatus of clause 35 wherein the vehicle information include one or more ego vehicle parameters.

Clause 41. The apparatus of clause 40 wherein the one or more ego vehicle parameters include a speed value, an acceleration value, a steering angle value, or combinations thereof.

Clause 42. The apparatus of clause 35 wherein the vehicle information includes an indication of an experience level of an operator of the vehicle.

Clause 43. The apparatus of clause 35 wherein the vehicle information includes an indication of an environmental condition proximate to the vehicle.

Clause 44. The apparatus of clause 35 wherein the at least one processor is further configured to provide the location information and the vehicle information as inputs to a neural network configured to output the safety margin perimeter profile.

Clause 45. The apparatus of clause 44 wherein the at least one processor is further configured to receive the neural network via a wireless communication link.

Clause 46. The apparatus of clause 35 wherein the at least one processor is further configured to transmit an indication of the safety margin perimeter profile to the vehicle.

Clause 47. An apparatus for activating an advanced driving assistance system (ADAS) function, comprising: means for obtaining one or more operation parameters for a vehicle; means for computing an asymmetric safety margin perimeter profile around the vehicle based at least in part on the one or more operation parameters; and means for activating a safety function for the vehicle based at least in part on a location of an object relative to the asymmetric safety margin perimeter profile.

Clause 48. An apparatus for computing a safety margin profile perimeter for a vehicle, comprising: means for obtaining location information associated with a geographic location; means for obtaining vehicle information associated with the vehicle operating proximate to the geographic location; and means for computing a safety margin perimeter profile for the vehicle based at least in part on the location information and the vehicle information.

Clause 49. A non-transitory processor-readable storage medium comprising processor-readable instructions configured to cause one or more processors to activate an advanced driving assistance system (ADAS) function, comprising code for: obtaining one or more operation parameters for a vehicle; computing an asymmetric safety margin perimeter profile around the vehicle based at least in part on the one or more operation parameters; and activating a safety function for the vehicle based at least in part on a location of an object relative to the asymmetric safety margin perimeter profile.

Clause 50. A non-transitory processor-readable storage medium comprising processor-readable instructions configured to cause one or more processors to compute a safety margin profile perimeter for a vehicle, comprising code for: obtaining location information associated with a geographic location; obtaining vehicle information associated with the vehicle operating proximate to the geographic location; and computing a safety margin perimeter profile for the vehicle based at least in part on the location information and the vehicle information.

1. A method for activating an advanced driving assistance system (ADAS) function, comprising:
obtaining one or more operation parameters for a vehicle;
computing an asymmetric safety margin perimeter profile around the vehicle based at least in part on the one or more operation parameters; and
activating a safety function for the vehicle based at least in part on a location of an object relative to the asymmetric safety margin perimeter profile.

2. The method of claim 1 wherein the asymmetric safety margin perimeter profile is not identical on both sides of a centerline running a length of the vehicle.

3. The method of claim 1 wherein the asymmetric safety margin perimeter profile is not identical on both sides of a centerline running a width of the vehicle.

4. The method of claim 1 wherein the one or more operation parameters include an ego vehicle parameter.

5. The method of claim 4 wherein the ego vehicle parameter includes a speed value, an acceleration value, a steering angle value, or combinations thereof.

6. The method of claim 1 wherein the one or more operation parameters includes location information.

7. The method of claim 1 wherein the one or more operation parameters includes an indication of an experience level of an operator of the vehicle.

8. The method of claim 1 wherein the one or more operation parameters includes an indication of an environmental condition proximate to the vehicle.

9. The method of claim 1 wherein the computing the asymmetric safety margin perimeter profile around the vehicle includes providing the one or more operation parameters as an input to a neural network configured to output the asymmetric safety margin perimeter profile.

10. The method of claim 9 further comprising receiving the neural network via a wireless communication link.

11. The method of claim 1 wherein the safety function is one of an autonomous emergency braking (AEB) system or a lane support system (LSS).

12. A method for computing a safety margin profile perimeter for a vehicle, comprising:
obtaining location information associated with a geographic location;
obtaining vehicle information associated with the vehicle operating proximate to the geographic location; and
computing a safety margin perimeter profile for the vehicle based at least in part on the location information and the vehicle information.

13. The method of claim 12 wherein in the safety margin perimeter profile is asymmetric relative to a centerline of the vehicle.

14. The method of claim 12 wherein the location information is an identification of a country and the geographic location includes an area defined by a border of the country.

15. The method of claim 12 wherein the location information includes map information configured to define the geographic location.

16. The method of claim 15 wherein the geographic location includes an intersection, a roadway, a driveway, a building, a parking area, or combinations thereof.

17. The method of claim 12 wherein the vehicle information include one or more ego vehicle parameters.

18. The method of claim 17 wherein the one or more ego vehicle parameters include a speed value, an acceleration value, a steering angle value, or combinations thereof.

19. The method of claim 12 wherein the vehicle information includes an indication of an experience level of an operator of the vehicle.

20. The method of claim 12 wherein the vehicle information includes an indication of an environmental condition proximate to the vehicle.

21. The method of claim 12 wherein the computing the safety margin perimeter profile for the vehicle includes providing the location information and the vehicle information as inputs to a neural network configured to output the safety margin perimeter profile.

22. The method of claim 21 further comprising receiving the neural network via a wireless communication link.

23. The method of claim 12 further comprising transmitting an indication of the safety margin perimeter profile to the vehicle.

24. An apparatus, comprising:
at least one memory;
at least one processor communicatively coupled to the at least one memory and configured to:
obtain one or more operation parameters for a vehicle;
compute an asymmetric safety margin perimeter profile around the vehicle based at least in part on the one or more operation parameters; and
activate a safety function for the vehicle based at least in part on a location of an object relative to the asymmetric safety margin perimeter profile.

25. The apparatus of claim 24 wherein the at least one processor is further configured to provide the one or more operation parameters as an input to a neural network configured to output the asymmetric safety margin perimeter profile.

26. The apparatus of claim 25 further comprising at least one transceiver communicatively coupled to the at least one processor, wherein the at least one processor is further configured to receive the neural network via a wireless communication link.

27. An apparatus, comprising:
at least one memory;
at least one transceiver;
at least one processor communicatively coupled to the at least one memory and the at least one transceiver, and configured to:
obtain location information associated with a geographic location;
obtain vehicle information associated with a vehicle operating proximate to the geographic location; and
compute a safety margin perimeter profile for the vehicle based at least in part on the location information and the vehicle information.

28. The apparatus of claim 27 wherein the at least one processor is further configured to provide the location information and the vehicle information as inputs to a neural network configured to output the safety margin perimeter profile.

29. The apparatus of claim 28 wherein the at least one processor is further configured to receive the neural network via a wireless communication link.

30. The apparatus of claim 27 wherein the at least one processor is further configured to transmit an indication of the safety margin perimeter profile to the vehicle.
